(19) United States
(12) Patent Application Publication
(10) Pub. No.: US 2012/0209157 A1
(43) Pub. Date: Aug. 16, 2012

(54) Massage Table for Recumbent or Seated Person

(76) Inventor: Jean-Jacques Racine, Franqueville Saint Pierre (FR)

(21) Appl. No.: 13/503,513

(22) PCT Filed: Oct. 22, 2010
(86) PCT No.: PCT/FR2010/000700

§ 371 Date: Apr. 23, 2012

(30) Foreign Application Priority Data
Oct. 23, 2009 (FR) 0905091

(51) Int. Cl. A61H 7/00; A61G 7/015

(52) U.S. Cl. 601/99; 5/617

(57) ABSTRACT

The invention relates to a massage or therapy table (1), constituted by a pedestal (2) intended to receive a set of moveable elements (3), characterized in that the moveable elements (3) comprise a plurality of height-adjustable rollers on which a person can rest in a lying and/or seated position, while in the space situated between two consecutive rollers a connecting strip intended to provide protection to the chest or back of the patient, and/or mouldings intended to provide side protection to the patient are fixed. Application to massages and other bodily treatments.

### FIELD OF THE INVENTION

The present invention relates to the field of treatment of persons who are lying or seated to allow them to perform exercises, undergo manipulation and/or treatment, for example for a massage operation or during the latter. It relates more particularly to a table device allowing adaptation to the contours and/or curvature of the body of the treated person, such that the table is adapted to the morphology of the treated person.

It thus relates more particularly to a novel type of table that can be adjusted by the practitioner and/or by the patient/client himself.

In the interest of simplicity, the type of table concerned here is called a “massage table”; the invention can be applied however to all other applications in which a patient/client is placed in a lying/seated position on a table to receive therapy, in particular massages. The application to massages is therefore preferred, but not limitative.

### TECHNOLOGICAL BACKGROUND

Currently, the comfort of the patient/client settling on a massage table is sought by positioning different types of cushions that have different shapes and heights.

The treated person is settled by the practitioner, who on the basis of his experience and using the patient/client's sensations, judges the height of the cushions to be used and their location on the table.

This process is therefore tiresome and requires:
time for setting up;
the knowledge and attendance of the practitioner;
an availability of a large number of cushions, with the corresponding possible storage requirement.

Moreover, more or less efficient systems are known for adapting therapy tables/beds for disabled persons or those for whom discomfort must be reduced during treatments. In this regard:

Document U.S. Pat. No. 5,235,710 A describes a therapy table for “invalids” in which the mattress is divided into independent sections that are adjustable in height.

It is not possible for the raising/lowering devices of these mattress portions to be assembled and integrated into a table base in any random order. On the contrary, they are fixed in a defined order in a double-walled space topped by a bath-type waterproof container, intended to allow the patient to be washed.

A flat horizontal position of all the mattress elements cannot be envisaged, and these elements can be laterally inclined.

The aim is to facilitate the nursing of “invalids” and to allow the selective replacement of the soiled portions of mattress protector. The pivoting provided (see column 3, lines 6-16) serves only to incline certain portions of the mattress laterally in order to allow the bed and/or the patient to be changed by thus causing the latter to turn by activating the jacks, under manual operation only.

Document DE 93 13 660 U1 describes a module for the adjustment of elements of a bed for medical use.

It is not possible to perform a massage operation with such equipment, given that the surfaces thus proposed, forming a padded cushion, are limited in number, each have a large load-bearing surface, can only be moved to a limited extent and are only adjustable in an inclined plane.

Document DE 93 18 662 U1 describes a massage couch having a padded frame and a portion for the feet, while in order to take account of the comfort of female patients for whom it may be uncomfortable if the bust is compressed in a face-down massage position, an intermediate height-adjustable portion is provided (N.B.: this is the only part that can be adjusted in this way) in order to alleviate the discomfort caused by the female patient resting on her bust on such a massage couch.

Document U.S. Pat. No. 3,821,952 A describes an adjustable chiropractic table. The padded table is height-adjustable overall and at one or both ends. Only a part for the legs (numbered 30′), distanced from the bed part but connected at 90° to the latter can be adjusted separately, but in this case lengthwise, in order to take account of the height of the patient.

The table includes at one end a narrower part to allow the patient to let his arms hang down, and a slot to allow the patient to rest his face without pain.

Document EP 0 354 271 A2 describes a non-modular mattress support, constituted by separate slats and joining tubes for setting the pressure of an adjusting fluid. The aim is to avoid the slats jamming in the frame where they are placed when moving diagonally.

Document DE 29 42 287 A1 describes a massage device in which arrays of modular massage elements can be moved by means of electromagnets in a direction perpendicular to the longitudinal axis of the massage table. One or more rows of massage modules can thus be moved at the same time, without the possibility of individualizing one or more elements within these modular elements forming a whole.

Thus, the problem that the present invention proposes to resolve was not even addressed according to the techniques described in these documents.

The problem that the present invention aims to resolve was not addressed, even implicitly, by the techniques described in these documents and others. And the device according to the present invention makes it possible to overcome the drawbacks of the equipment of the prior art.

The table device for massage and other therapy according to the present invention is on the contrary designed in order to allow, whatever the application thus envisaged, an improved use and comfort that can be personalized for the patient/client, who can then have different parameters of structure and/or equipment of the table adapted without difficulty to their convenience, or can even themselves carry out the adaptation according to their own needs and/or the stage of progress of the massages and other treatments.

Said table is intended to improve the quality of the therapy and massages given and is more practical to handle and to adjust than existing tables. It moreover allows easy and programmed adaptation for each individual patient, according to parameters taking into account morphology, the type of therapy to be given and/or the character of each patient.

### SUMMARY OF THE INVENTION

The present invention aims to propose a novel type of massage table, adjustable directly by the patient and/or the practitioner to take account of the morphology of the treated person, while dispensing with the use of cushions for adjustment.

In the device according to the invention, the table is no longer in a single piece like the standard massage tables, but is constituted by units forming adjustable-height roller modules. In such an arrangement, the table becomes moveable and adapts to the body contours and curvature of the person lying or seated on the table.

The invention thus relates to a massage or therapy table, constituted by a pedestal intended to receive a set of moveable elements, in which the moveable elements comprise a plurality of height-adjustable rollers on which a person can rest in a lying and/or seated position, while in the gap situated between two consecutive rollers a connecting strip intended to provide chest or back protection for the patient, and/or mouldings intended to provide side protection for the patient are fixed.

### BRIEF DESCRIPTION OF THE DRAWINGS

The invention will be better understood, and other aims, advantages and features of the latter will become more clearly apparent in the light of the detailed description hereinafter of preferred embodiments provided non-limitatively for illustration purposes only, together with the drawings attached to said description in which:

FIG. 1 shows diagrammatically a vertical cross-section of an embodiment of a complete massage table according to the invention.

FIG. 2 shows diagrammatically a vertical cross-section of an embodiment of a complete massage table according to the invention, in a version with a backrest that can be inclined manually or electrically.

FIG. 3 shows diagrammatically in cross-section and in section along A-A, a roller unit intended for a massage table according to the invention.

FIG. 4 shows diagrammatically a cross-section a method of fixing a safety strip between two rollers of a roller unit according to FIG. 3.

FIG. 5 shows an end elevation view and a diagrammatic section along A-A of a roller including a drawer 4 with a fragrance block 5, fan 6 and LED 7.

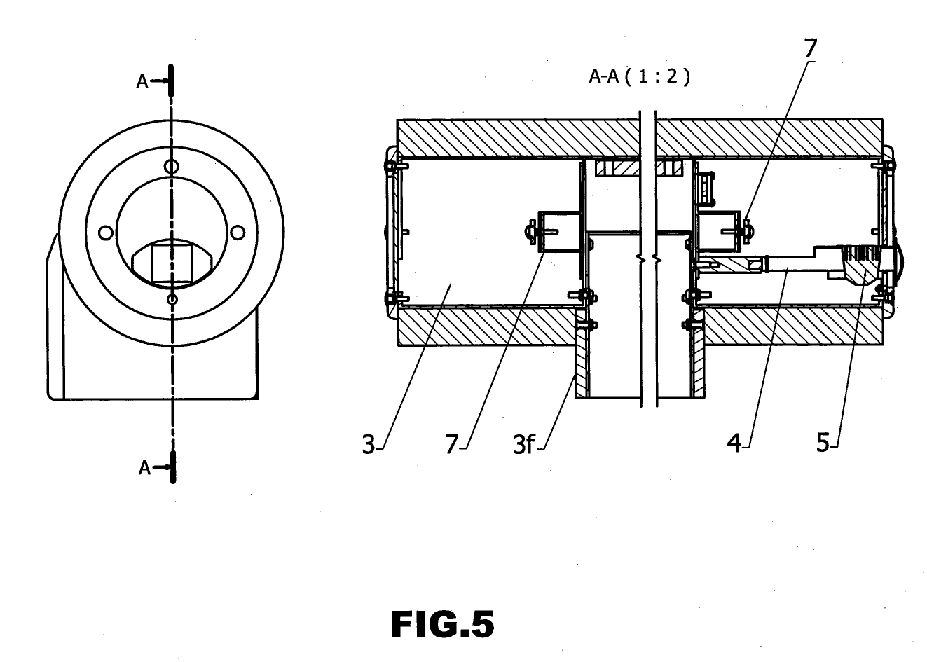

### DETAILED DESCRIPTION OF THE INVENTION

With reference to the drawings thus briefly described that illustrate the invention without limiting it in any way, the massage or therapy table 1 according to the invention is constituted by a pedestal 2 intended to receive a set of moveable elements 3. The moveable elements 3 comprise rollers that are substantially horizontal, height-adjustable and on which a person can rest in a lying position, while in the gap between two consecutive rollers a connecting strip 3g, providing chest or back protection for the patient, and/or mouldings 3f providing side protection for the patient are fixed.

The rollers 3 are advantageously powered by a motorized rack and pinion system. They can however be powered by any other motorization system known to a person skilled in the art or be manually controlled.

Each of the rollers of the set of rollers 3 forms part of a unit comprising:
1 roller with cover 3a,
2 racks 3b,
1 drive shaft 3c, in practice with pinions, and
1 electric motor or other motorization system 3d allowing the rollers 3a to be raised and lowered.

In practice, in the massage or therapy table according to the invention, the pedestal 2 on which the set of rollers 3 is mounted comprises moreover the electronic equipment required for operation of the table.

In an embodiment of the massage or therapy table, the rollers 3 are covered with a synthetic material.

In a supplementary or alternative embodiment, the rollers 3 are height-adjustable, while management of this height adjustment can be carried out under the control of a standard electronic control box.

In advantageous implementations of the different aspects of the invention, one or other of the following arrangements/modes can be used, separately or in combination:
The rollers can be of different sizes, if it is desired to allocate to each one a function that is more closely adapted to the part of the patient's body to which it relates.
The rollers can have different shapes and/or sizes, within limits that a person skilled in the art will easily envisage. However, the rollers are preferably all or substantially all of the same size or are close in size.
The rollers have an outer shape that is generally substantially cylindrical, but this functional shape that is provided by foam or another flexible outer material can be supported on a core of any shape, for example a square- or rectangular-section tube or a U-shaped rail and not only a cylinder or a half-cylinder.
The rollers can be limited to half-rollers, or fractions of rollers, in order to allow an economy of material and/or volume of the units containing them. In this case, if a foam covering of the rollers is provided, it is advantageous for the latter to closely fit the longitudinal periphery of said rollers, but to have itself an outer surface that is substantially cylindrical in shape.
It is possible for not all of the rollers to have the same longitudinal dimension.
The characteristics of the foam covering of said rollers, such as for example hardness, thickness, shape, etc., can be chosen as convenient.
Some or all of the rollers can be equipped with heating elements.
The system for raising the rollers can comprise electric motors, hydraulic cylinders, or be manual.
The rollers are preferably fixed on their horizontal axis.
The rollers can be moveable, in particular by rotation or by oscillation along their longitudinal axis.
The drive systems by motors, rack and pinion assemblies are incorporated as far as possible into the rollers.
The motors, rack and pinion assemblies for moving the rollers are actuated by means of a main supply, advantageously incorporated into the pedestal of the table and connected to the devices for operating the rollers by suitable functional wiring, for example electric wiring.
Raising and/or lowering the individual rollers can be conveniently operated/adjusted independently, for example in such a way as to be able to provide a wave effect with relaxing properties.
The massage table can include, in one or more suitable locations that can easily be determined by a person skilled in the art after trial tests, one or more drawers capable of receiving materials that can provide a fragrance, in particular by a perfume capsule, as well as LEDs that are identical or different in order to generate visual effects, and/or speakers connected to a sound broadcasting device for sound effects, in particular musical effects and/or pre-recorded instructions broadcast by this device. These additional elements can be reserved for some rollers, jointly or separately.
The drawers for diffusing fragrance can be reserved for the end rollers and can be functionally combined with at least one fan also incorporated into said rollers.
The foams covering the rollers can be partially or totally replaced by a silicone element, in particular transparent silicone. In the latter case, a chromotherapy effect can be incorporated into at least some of the rollers, using known means for the production and distribution of light for this purpose.
The motors controlling the rollers, in particular for height-adjusting the rollers, as well as the optionally associated racks, can be incorporated into said rollers and thus achieve an economy of space.
The above-mentioned optional additional functionalities can be operated via a software application, advantageously of the type of those that can be integrated into touchpads or smartphones, in particular of the type known under the trade names iPhone or iPad, for control by wireless link of the WiFi or other type.
An overall vertical elevation system of the table, for suitable height adjustment thereof, in particular for improved comfort of the attending practitioner, can also be provided.

In an advantageous embodiment, the abovementioned wave effect can be achieved by successive lowering and raising of at least some of the rollers equipping the table. It can be carried out by manual operation or preferably in an automated fashion, advantageously according to a pre-recorded programme, with the capability of varying the speed and vertical amplitude or course of the movements.

In an equally advantageous embodiment, the pedestal of the table does not incorporate, or only incorporates a minority of the abovementioned functional elements. In this case, it can adopt any shape and thus can form part, by suitable design or style, of the visual identity and/or to the personalization of the massage table.

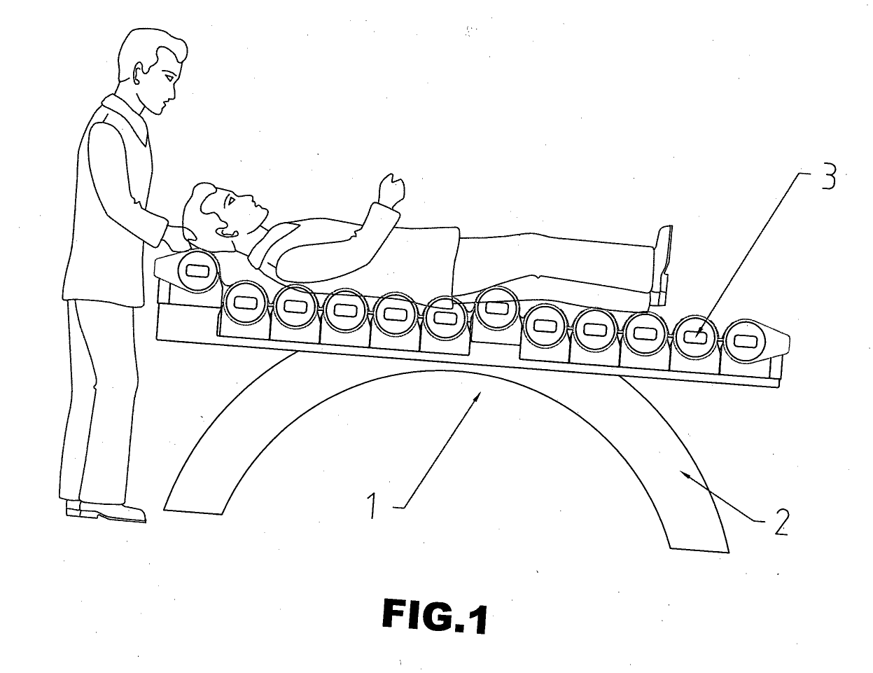

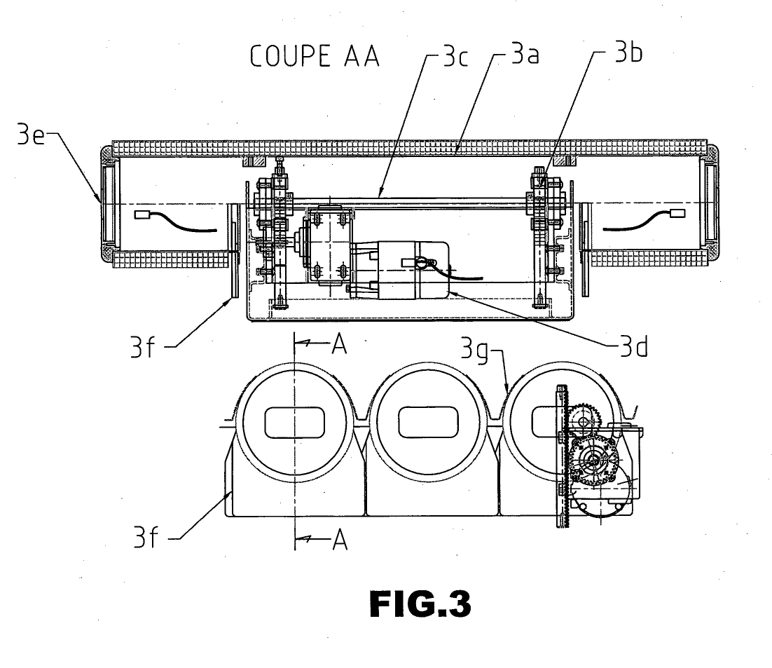

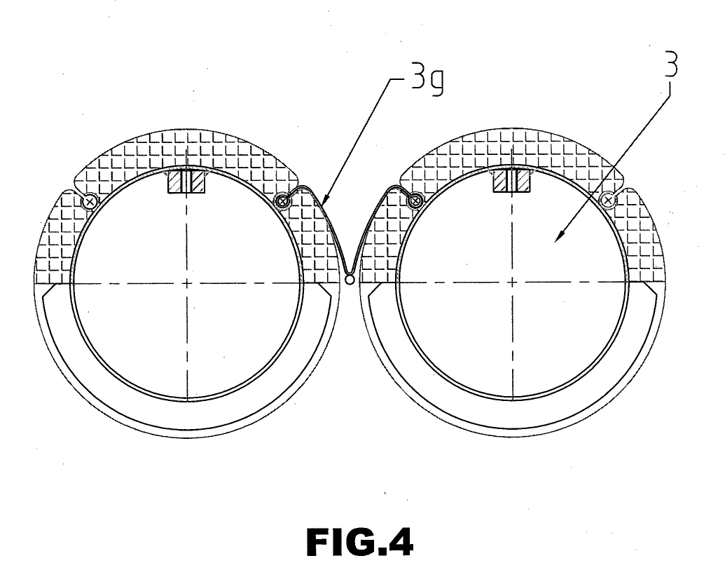

By way of an illustrative and non-limitative example, an embodiment is detailed hereinafter as shown diagrammatically in the attached FIGS. 1-4.

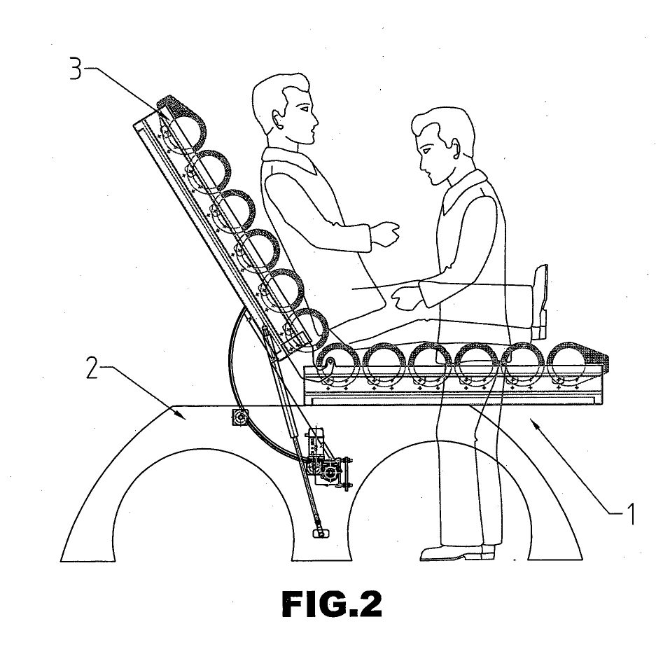

The table shown in FIGS. 1-2 is intended to take a lying or seated person in order to allow him to carry out exercises, undergo manipulation and/or treatment, for example during a massage operation. It enables adaptation to the contours and curvature of the body. The table adapts to the morphology of the “treated” person.

The table according to the invention is referred to hereinafter as a massage table, but a person skilled in the art will understand that it can be used in other applications.

Thus, in an advantageous implementation, the different elements of the table can be arranged and operated to carry out their upward and downward movements following a defined programme, providing the table itself with an undulating movement like that of a wave, allowing the patient/client resting thereon to experience these effects (relaxation, relief from tension, gentle bodily stretching).

It can be adjusted by the practitioner and/or the patient/client.

While the equipment that is currently known requires:
time for setting up
knowledge and attendance of the practitioner, as well as
availability of a large number of cushions (possible storage problem).

The device according to the invention allows these drawbacks to be overcome. It constitutes a massage table that can be adjusted directly by the patient and/or the practitioner, according to the morphology of the treated person, without the use of cushions. The table is no longer in a single piece like standard massage tables, but is constituted by height-adjustable roller module units. Thus, it is the table that becomes moveable and is adapted to the contours of the body.

In the embodiment shown in FIGS. 1-2, the table includes 12 rollers, but it can equally well comprise between 8 and 16, and preferably between 10 and 14.

This example relates to a device constituted by rollers of the same size and independently motorized, with vertical elevation and capable of locking at the desired height.

This device can be adjusted at any time during the session/treatment.

The adjustment is carried out via an electronic control that manages the twelve rollers constituting the table independently and is managed by the patient and/or the practitioner.

The elevation of each roller is carried out by a rack and pinion system powered by an electric motor.

Moreover, the movements of the different rollers can be organized and programmed such that their vertical courses (raise and lower), produce a wave-type undulation of the table. This wave movement produces a sensation of stretching, relaxation and wellbeing in the patient/client.

Generally, this novel type of massage and therapy table is constituted by a pedestal intended to support a table on which a person can rest in a lying position and is characterized in that:

The pedestal is the structure on which the table is to be incorporated. It is designed such that it can receive the necessary electronics for the satisfactory operation of the massage table.

The table is constituted by twelve units each constituted by:
a roller
two racks
a drive shaft
an electric motor.

The rollers are managed using an electronic control box that enables the height adjustment of each roller individually.

As a material allowing the rollers to be covered, it is possible to use synthetic materials providing comfort in use, for example, a thermocompressed foam.

The novel type of table according to the invention, in its embodiment as shown in the attached figures, is denoted by the general reference 1. It is thus constituted by a pedestal denoted by the reference 2 supporting a set of rollers reference 3 on which a person can rest in a lying position.
The pedestal 2 is constituted in such a way that it will contain the electronics required to operate the table, possibly incorporating an audio set and a perfume diffuser, (possible options).

The set of rollers 3 is constituted by twelve units, each unit being constituted by:
1 foam-covered roller 3a,
2 racks 3b,
1 drive shaft 3c equipped with 2 pinions,
1 electric motor 3d for raising and lowering the roller,
1 light strip 3e (optional).

Patient safety is provided by the mouldings 3f and/or a connecting strip 3g between two rollers.

Raising and lowering of the rollers is managed by an electronic control box operated either by the patient or by the practitioner.

Of course, the invention is not limited to the specific embodiment described and it is possible to envisage:
a backrest that can be raised manually or electrically;
a specific design according to the practice or gym, for example for the pedestal;
a specific covering for the rollers (colour, texture, etc.);
a multi-coloured light strip incorporated into the rollers;
a wireless remote control for adjusting the height of the rollers, the music or perfume diffuser;
choice of colour for the mouldings.

In another embodiment, the set or a part of the rollers 3, the strips 3g and/or the mouldings 3f are replaced by a technical equivalent constituted by a covering mat (not shown) or one or more superimposed covering mats over a deformable support element, the whole then being capable of activation upwardly and downwardly and/or in undulations by means equivalent to those described above.

This table according to the invention is particularly intended for providing therapy, and/or the application of manual or mechanical techniques on a patient/client.

1. Massage or therapy table, comprising a pedestal (2) and a set of moveable elements (3) received on the pedestal, wherein the moveable elements (3) comprise
a plurality of height-adjustable rollers on which a person can rest in a lying and/or seated position, and
a connecting strip (3g) fixed in the space situated between two consecutive rollers to provide protection to the chest or back of the patient, mouldings (3f) to provide side protection to the patient are fixed or a covering mat or mats superimposed onto a deformable support element.

2. Massage or therapy table according to claim 1, wherein the moveable elements comprise between 8 and 16 rollers.

3. Massage or therapy table according to claim 1, wherein the rollers are powered by a motorized rack and pinion system.

4. Massage or therapy table according to claim 1, wherein each of the moveable elements of the set of rollers (3) is formed as a unit comprising:
1 roller with covering (3a),
2 racks (3b),
1 drive shaft (3c), in practice with pinions, and
1 electric motor or other motorization system (3d) allowing the rollers (3a) to be raised and lowered.

5. Massage or therapy table according to claim 1, wherein the pedestal (2) on which the set of moveable elements (3) is mounted contains electronic equipment required for operation of the table.

6. Massage or therapy table according to claim 1, wherein the rollers are covered with a synthetic material.

7. Massage or therapy table according to claim 1, wherein the height adjustment of the rollers is carried out under the control of an electronic control box.

8. Massage or therapy table according to claim 1, wherein the table includes one or more secondary features selected from the group consisting of:
the rollers are of different shapes and/or sizes;
the system for raising the rollers comprises electric motors or hydraulic cylinders;
the rollers are fixed on their horizontal axis or can be moved by rotation or by oscillation along their longitudinal axis;
the rollers are limited to half-rollers, or fractions of rollers;
I. the rollers do not all have the same longitudinal dimension;
some or all of the rollers are be equipped with heating elements;
the table contains one or more drawers capable of receiving materials that can provide a fragrance, in particular by a perfume capsule, as well as LEDs that are identical or different in order to generate visual effects, and/or speakers connected to a sound broadcasting device for sound effects;
the rollers are covered by transparent silicone;
the drive systems by motors, rack and pinion assemblies are incorporated into the rollers;
the motors, rack and pinion assemblies for moving the rollers are actuated by means of a main supply, advantageously incorporated into the pedestal of the table and connected to the devices for operating the rollers by suitable electrical wiring; and
raising and/or lowering the individual rollers can be conveniently controlled/adjusted independently, in such a way as to be able to provide a wave effect with relaxing properties.

9. Massage or therapy table according to claim 1, wherein a wave effect is achieved by successive lowering and raising of at least some of the rollers equipping the table by advantageously operating according to a pre-recorded programme.

10. (canceled)

11. Massage or therapy table according to claim 1, wherein the moveable elements comprise between 10 and 14 rollers.

12. Massage or therapy table according to claim 1, wherein the moveable elements comprise 12 rollers.

13. Massage or therapy table according to claim 2, wherein the rollers are powered by a motorized rack and pinion system.

14. Massage or therapy table according to claim 2, wherein each of the moveable elements (3) is foamed as a unit comprising:
1 roller with covering (3a),
2 racks (3b),
1 drive shaft (3c), in practice with pinions, and
1 electric motor or other motorization system (3d) allowing the rollers (3a) to be raised and lowered.

15. Massage or therapy table according to claim 2, wherein the pedestal (2) on which the set of moveable elements (3) is mounted contains electronic equipment required for operation of the table.

16. Massage or therapy table according to claim 2, wherein the rollers are covered with a synthetic material.

17. Massage or therapy table according to claim 2, wherein the height adjustment of the rollers is carried out under the control of an electronic control box.

18. Massage or therapy table according to claim 2, wherein the table includes one or more secondary features selected from the group consisting of:
the rollers are of different shapes and/or sizes;
the system for raising the rollers comprises electric motors or hydraulic cylinders;
the rollers are fixed on their horizontal axis or can be moved by rotation or by oscillation along their longitudinal axis;
the rollers are limited to half-rollers, or fractions of rollers;
II. the rollers do not all have the same longitudinal dimension;
some or all of the rollers are be equipped with heating elements;
the table contains one or more drawers capable of receiving materials that can provide a fragrance, in particular by a perfume capsule, as well as LEDs that are identical or different in order to generate visual effects, and/or speakers connected to a sound broadcasting device for sound effects;
the rollers are covered by transparent silicone;
the drive systems by motors, rack and pinion assemblies are incorporated into the rollers;
the motors, rack and pinion assemblies for moving the rollers are actuated by means of a main supply, advantageously incorporated into the pedestal of the table and connected to the devices for operating the rollers by suitable electrical wiring; and
raising and/or lowering the individual rollers can be conveniently controlled/adjusted independently, in such a way as to be able to provide a wave effect with relaxing properties.

19. Massage or therapy table according to claim 2, wherein a wave effect is achieved by successive lowering and raising of at least some of the rollers equipping the table by advantageously operating according to a pre-recorded programme.

20. Massage or therapy table according to claim 2, wherein the moveable elements comprise between 10 and 14 rollers.

21. Massage or therapy table according to claim 2, wherein the moveable elements comprise 12 rollers.
